(19) United States
(12) Patent Application Publication
(10) Pub. No.: US 2020/0180387 A1
(43) Pub. Date: Jun. 11, 2020

(54) AIR-CONDITIONING SYSTEM FOR A VEHICLE

(71) Applicant: Audi AG, 85045 Ingolstadt (DE)

(72) Inventor: RHAGAV SARMA, Grossmehring (DE)

(73) Assignee: Audi AG, 85045 Ingolstadt (DE)

(21) Appl. No.: 16/315,980

(22) PCT Filed: Apr. 28, 2017
(86) PCT No.: PCT/EP2017/000532

§ 371 Date: Jan. 7, 2019

(30) Foreign Application Priority Data
Jul. 8, 2016 (DE) 10 2016 008 366.2

(51) Int. Cl. B60H 1/00; B60H 3/06; B60H 1/24

(52) U.S. Cl. CPC B60H 1/008; B60H 1/00007; B60H 1/00985; B60H 1/24; B60H 3/06; B60H 1/00657; B60H 1/00778

(57) ABSTRACT

An air-conditioning system for a vehicle includes at least one sensor unit which senses an air-quality-relevant variable of the air of the passenger compartment of a vehicle, an evaluation and control unit which evaluates the air-quality-relevant variable and an air-purification device which purifies the air of the passenger compartment in a circulation mode or in a fresh air mode or in a mixed air mode. The evaluation and control unit activates the air-purification device if the air quality of the passenger compartment satisfies at least one predefined criterion. A starting signal in the state of rest of the vehicle activates the air-conditioning system which then determines the current air quality in the passenger compartment and activates the air-purification device as a function of the current air quality in the passenger compartment. The air-purification device purifies the air of the passenger compartment before a time of departure.

The invention relates to an air-conditioning system for a vehicle according to the preamble of claim 1.

Air quality and/or air pollution is considered daily in China and Asia and is also increasingly a center of attention in other regions. Vehicle customers want a clean passenger compartment with good air quality even if the outside air is heavily polluted. Therefore, modern air-conditioning systems for vehicles are equipped with at least one sensor unit, which detects at least one air-quality-relevant variable of the vehicle passenger compartment, an evaluation and control unit, which evaluates the at least one air quality-relevant variable and an air purification device. The air purification device purifies the cabin air of the vehicle in a recirculation mode or in a fresh air mode or in a mixed mode. The evaluation and control unit activates the air purification device when the air quality in the vehicle passenger compartment determined from the at least one air-quality-relevant variable fulfills at least one predefined criterion.

In addition, remote control systems with a portable remote control unit and an onboard communication device are known. For example, before starting to trip, a parking heater can be activated and/or programmed via the portable remote control unit.

From DE 20 2005 002 221 U1, a control module for controlling a generic air-conditioning system for the treatment of air in an enclosed interior space of a vehicle is known. The control module includes a plurality of sensors which detect different chemical components of at least one airflow. The control module also includes a processor unit, which generates a control signal for controlling the air-conditioning system on the basis of the signals from the sensors. A first air flow to be examined is tapped outside the closed vehicle passenger compartment and fed to a sensor for outside air. A second air flow to be examined is tapped from the closed vehicle passenger compartment. At least three sensors examine the passenger compartment air. A first sensor has a higher selectivity for carbon monoxide and/or hydrogen. A second sensor has a higher selectivity for nitrogen oxides. A third sensor has a higher selectivity for hydrocarbons. The processor unit contains an algorithm which subtracts from the signals of the sensors for the air of the passenger compartment a non-orthogonal part of the signals of the sensor for the outdoor air and calculates therefrom a characteristic for a particular state. The characteristic is representative of the current composition of the examined air of the passenger compartment without the influence of the outside air. Furthermore, the characteristic is compared to predetermined characteristics stored in the processor unit for a particular state for different scenarios of a possible air composition.

From DE 10 2014 01 1 622 A1, a method for operating a ventilation device for supplying a passenger compartment of a vehicle with air is known. The method includes a step in which at least one first parameter is determined, which characterizes a quality of the ambient air. In a further step, at least one second parameter is determined, which characterizes a function of the ventilation device with regard to purifying the air supplied to the passenger compartment. In a further step, a third parameter is determined as a function of the first parameter and of the second parameter, which characterizes at least one quality of the passenger compartment air.

It is the object of the invention to provide an air-conditioning system for a vehicle, which has an improved purification function for the air of the passenger compartment.

According to the invention, the object is achieved by providing an air-conditioning system for a vehicle having the features of claim 1. Advantageous embodiments and further developments of the invention are specified in the dependent claims.

In order to provide an air-conditioning system for a vehicle, which has an improved purification function for the air of the passenger compartment, a start signal in the idle state of the vehicle activates an evaluation and control unit, which determines with at least one sensor unit a current air quality in the passenger compartment and activates as a function of the current air quality in the passenger compartment an air purification device, which purifies the air of the passenger compartment before a time of departure.

The term air quality is to be understood in the following as the combination of a particle concentration, a concentration of interfering gas and a concentration of deliberate gases. The particle concentration may here be dependent on a pollen concentration and/or a dust concentration and/or a fine dust concentration and/or a mold spore concentration and/or a bacterial and viral concentration. The interfering gases may correspond to organic compounds. Furthermore, the interfering gases may correspond to ammonia and/or carbon dioxide and/or reducing gases, such as hydrogen sulphide. A deliberate gas may correspond to oxygen. The air quality can advantageously be determined by an air quality sensor which determines the particle concentrations and/or interfering gas concentrations and compares them with stored limit values.

An idle state of the vehicle refers in the following to a parked or stopped state of the vehicle, wherein no occupants are inside the vehicle.

Advantageously, the air-conditioning system according to the invention includes the air purification device, which purifies the air of the passenger compartment not only while driving, but also in the idle state of the vehicle before starting a trip. The concentration of the interfering particles and/or interfering gases can hereby be lowered to a value below predetermined limit values. The concentration of the desired gases can be increased to a value above predetermined limit values. Advantageously, the passenger compartment air is treated prior to departure so that the passenger compartment air is perceived as pleasant by an occupant entering the vehicle. Furthermore, unhealthy or harmful elements can be filtered out and/or neutralized from the passenger compartment air before the time of departure to reduce the risk to the occupants. Advantageously, a vehicle, which is parked in an environment with unpleasant and/or unhealthy or harmful ambient air, can then have pleasant air in the passenger compartment at the time of departure. The aforedescribed limit values can be specified as criteria for activating or deactivating the air purification device.

Subsequently, the air purification device removes air from the vehicle passenger compartment in air recirculation mode, purifies the air and feeds the purified air from the vehicle passenger compartment back to the vehicle passenger compartment. In fresh air mode, the air purification device discharges air from the vehicle passenger compartment into the vehicle surroundings and only supplies fresh air from the vehicle environment to the vehicle passenger compartment. In mixed mode, the air purification device takes in air from the vehicle passenger compartment and diverts a first portion of this air into the vehicle surroundings and purifies a second portion of the extracted air and mixes the purified air portion from the vehicle passenger compartment and a proportion of fresh air from the vehicle environment and supplies the mixture to the vehicle passenger compartment. In fresh air mode and in mixed mode, the air purification device can purify the supplied fresh air from the vehicle environment beforehand.

In an advantageous embodiment of the air-conditioning system according to the invention, the air purification device may include at least one purification unit. In this case, a first purification unit can be designed as a filter device with at least one filter element. Advantageously, the filter element can separate interfering particles and/or neutralize interfering odors.

Additionally or alternatively, a second purification unit can be designed as a plasma purifier with at least one electrostatic filter. Advantageously, dust and/or fine dust and/or dirt particles and/or pollen can be collected by the electrostatic filter and removed from the passenger compartment air with the plasma air purifier. Furthermore, mold spores and/or bacteria and/or viruses can be essentially rendered harmless with the plasma air purifier. Furthermore, the plasma air purifier can be deactivated when the passenger compartment is occupied, since the activated plasma purifier can produce ozone. Advantageously, the effective operation of the plasma purifier can be used before the start of the trip or before the occupants enter the vehicle to purify the air in the passenger compartment.

Additionally or alternatively, a third purification unit can be designed as an ozone purifier. Advantageously, ammonia and/or organic compounds and/or reducing gases such as hydrogen sulphide can be removed from the air of the passenger compartment by ozone purge. Unpleasant odors, such as tobacco odors and/or wastewater odors and/or burning odors, can advantageously be partially or completely neutralized by an ozone purifier. Furthermore, mold spores and/or bacteria and/or viruses can be partially or completely rendered harmless with the ozone purifier. Since ozone irritates the respiratory system, it makes sense to deactivate the ozone purge while the passenger compartment is occupied. Furthermore, the ozone purifier can be deactivated before the occupant enters. Here, a time interval between the deactivation of the ozone purifier and the occupant entering the vehicle can be chosen so that the ozone is degraded and/or filtered from the passenger compartment, before the occupant enters. Embodiments of the air purification device may include all or only one or any combination of the described purification units. Additionally or alternatively, the air purification device may also include other non-described purification units suitable for purifying the passenger compartment air.

In a further advantageous embodiment of the air-conditioning system according to the invention, a programmable wake-up unit and/or a remote control unit can generate the start signal and output the same to the evaluation and control unit. In this case, the wake-up unit may be arranged in the vehicle and/or in the remote control unit. In addition, the remote control unit may transmit the start signal via a wireless communication link to the vehicle in the idle state. The wake-up unit may be programmed via the remote control unit and/or an operating unit in the vehicle. For example, a user may enter via the remote control unit or the vehicle-side control element a time interval until the time of departure and/or the actual time of departure. Advantageously, the evaluation and control unit can determine from the time of departure and the current air quality in the passenger compartment the time interval required for the purifying of the air of the passenger compartment and the start time and output the same to the wake-up unit, which then transmits to the evaluation and control unit the start signal to activate the air purification device. Alternatively, the evaluation and control unit can calculate the time of departure from the current time and the specified time interval. Alternatively or additionally, the user may specify via the remote control or the operating unit a threshold value for the desired air quality at the time of departure. The portable remote control unit can be integrated, for example, in an electronic car key. Alternatively, the remote control unit may be implemented as a mobile data device, such as a mobile phone, tablet, etc. The mobile data device may advantageously establish a wireless communication connection to the vehicle and transmit the start signal and/or other operating signals to the evaluation and control unit in the vehicle.

In a further advantageous embodiment of the air-conditioning system according to the invention, the at least one sensor unit may detect at least one air-quality-relevant variable of a vehicle environment and transmit the same to the evaluation and control unit, which can then evaluate the air-quality-relevant variable of the vehicle environment.

In a further advantageous embodiment of the air-conditioning system according to the invention, the at least one sensor unit may detect a temperature in the vehicle passenger compartment and transmit the same to the evaluation and control unit, which can evaluate the passenger compartment temperature and compare the same with at least one predetermined temperature threshold value.

This enables the evaluation and control unit to switch the fresh air mode or mixed air operation of the air purifier into the recirculation mode or to switch the recirculation mode of the air purifier into the fresh air mode or into the mixed air mode as a function of air-quality-relevant variable of the vehicle environment and/or the air-quality-relevant variable of the passenger compartment and/or the passenger compartment temperature. Thus, the evaluation and control unit can switch the air purification device into the recirculation mode when the quality of the ambient air is worse than the quality of air of the passenger compartment. Alternatively, the evaluation and control unit can switch the air purification device into the fresh air mode or mixed air operation when the quality of the ambient air is better than the quality of the air of the passenger compartment to accelerate the purification process.

In a further advantageous embodiment of the air-conditioning system according to the invention, the evaluation and control unit can determine an activation time and/or a deactivation time and/or a purification interval and/or purification performance of the air purification device depending on the air quality to be achieved in the vehicle passenger compartment at the time of departure and in dependence on the current air quality in the vehicle passenger compartment and/or the current air quality in the vehicle environment. Advantageously, the evaluation and control unit can calculate an activation time which is as close as possible to the time of departure, so that the air purification device is activated for the shortest possible time in order to save energy. Furthermore, the evaluation and control unit can advantageously calculate a deactivation time, thereby defining a period of time during which the ozone produced by the purification can be timely broken down before the time of departure. Furthermore, the evaluation and control unit can advantageously determine a purification interval which allows the shortest possible runtime intervals of the respective purification unit of the air purification device. Furthermore, the purification performance of the respective purification unit of the air purification device can advantageously be set so that the vehicle passenger compartment can be purified with minimal energy consumption and/or minimum damage to the material. In this case, the evaluation and control unit may, for example, set a fan so as to create a strong or weak air flow through the purification units. Furthermore, the evaluation and control unit may set an ion and/or ozone quantity generated and supplied by the purification unit. Advantageously, the air of the passenger compartment can be purified and refreshed at the time of departure by a suitable choice of the activation time and/or the deactivation time and/or the purification interval and/or the purification performance of the at least one purification unit of the air purification device.

In a further advantageous embodiment of the air-conditioning system according to the invention, the evaluation and control unit can deactivate the air purification device if the air quality in the passenger compartment satisfies at least one predetermined second criterion.

In a further advantageous embodiment of the air-conditioning system according to the invention, the evaluation and control unit can activate a heating device which increases the temperature in the vehicle passenger compartment when the passenger compartment temperature is below a predetermined first temperature threshold value. Alternatively, the evaluation and control unit can activate a cooling device which lowers the temperature in the vehicle passenger compartment when the passenger compartment temperature is above a predetermined second temperature threshold value. The evaluation and control unit can thus calculate activation times and/or deactivation times for the heating device or cooling device. By an appropriate choice of the activation time and/or the deactivation time and/or the heating and/or cooling interval and/or the heating and/or cooling capacity of the at least one heating device or the at feast one cooling device, the passenger compartment air can then have the desired temperature at the time of departure in addition to desired quality. Thus, the operating time of the air purification device and the operating time of the heating or cooling device can be selected so that both the desired target temperature and the desired air quality are achieved in the passenger compartment at the time of departure. The control unit in the vehicle and/or the remote control unit make it possible to set both the desired temperature and the desired air quality. The fresh air operation or the recirculating air operation or the mixed air operation of the air-conditioning system can advantageously be selected so that an optimum of air quality, defogging and passenger compartment temperature is achieved.

In a further advantageous embodiment of the air-conditioning system according to the invention, the evaluation and control unit can receive status information of a vehicle locking system and at least partially deactivate the air purification device if the status information of the vehicle locking system indicates that at least one vehicle door has changed from the locked state to the unlocked state. Advantageously, by unlocking at least one vehicle door, an early time of departure can be detected by the evaluation and control unit so that at least one existing plasma air purifier and/or ozone purifier of the air purification system can be deactivated. As a result, only harmless filter elements can be in the activated state just before the start of the trip.

In a further advantageous embodiment of the air-conditioning system according to the invention, the evaluation and control unit can issue a warning message via an optical and/or acoustic warning device if the air purification device is activated at the time of unlocking. The evaluation and control unit can output the warning message, for example, for a predetermined period of time and/or display via the warning message a time at which the vehicle can be entered. If, for example, it is detected via an unlocking signal that the vehicle is to be entered before the scheduled time of departure and that an air purification process, such as an ozone purge, is active, which can represent a health hazard for the occupants, the driver can advantageously be warned via an optical and/or acoustic warning signal that the vehicle should be entered only after a predetermined period of time or at a predetermined time.

An embodiment of the invention is illustrated in the drawing and will be explained in more detail in the following description. In the drawing, like reference numerals designate components that perform the same or analog functions. In the following:

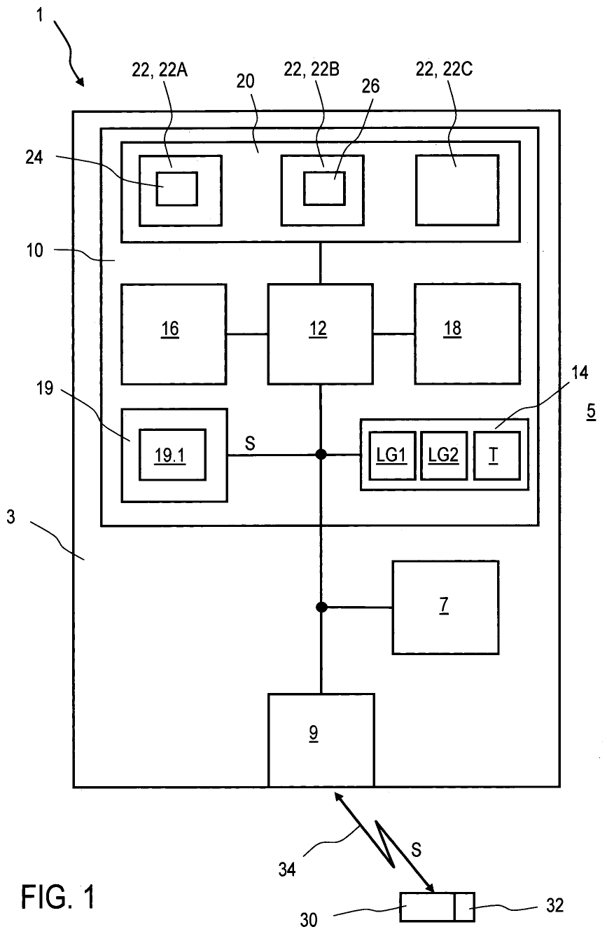

FIG. 1 shows a schematic block diagram of an exemplary embodiment of a vehicle with an air-conditioning system according to the invention.

As can be seen from FIG. 1, an air-conditioning system 10 for a vehicle 1 includes an evaluation and control unit 12, at least one sensor unit 14 and an air purification device 20. The at least one sensor unit 14 detects an air-quality-relevant variable LG1 in the vehicle passenger compartment 3. The evaluation and control unit 12 evaluates the at least one air-quality-relevant variable LG1. The air purification device 20 purifies the air inside the vehicle 1 in a recirculation mode or in a fresh air mode or in a mixed-air mode, wherein the evaluation and control unit 12 activates the air purification device 20 when the air quality determined from the at least one air quality-relevant variable LG1 in the vehicle passenger compartment 3 meets at least one predetermined first criterion.

According to the invention, a start signal S activates the evaluation and control unit 12 in the idle state of the vehicle 1 and determines the current air quality in the passenger compartment 3 via the at least one sensor unit 14 and activates, in dependence on the current air quality in the passenger compartment 3, the air purification device 20, which purifies the air of the passenger compartment before a time of departure.

As further evident from FIG. 1, the air purification device 20 includes several purification units 22. A first purification unit 22 is designed as a filter device 22A having at least one filter element 24, a second purification unit 22 is designed as a plasma air purifier 22B having at least one electrostatic filter 26, and a third purification unit 22 is designed as an ozone purifier 22C. In an alternative embodiment, not shown, other purification units 22 or another combination of purification units 22 may be used.

In the illustrated embodiment, the filter element 24 of the filter device 22A has a carbon layer, which aids in the deposition of dust particles. Dust, particulate matter, dirt particles and/or pollen are collected by the electrostatic filters 26 via the plasma air purifier 22B. The ozone purifier 22C reduces reducing gases such as hydrogen sulfide, ammonia and/or organic compounds. Unpleasant odors, such as odors from tobacco, waste water and/or burning odors, can be neutralized. Both the ozone purifier 22C and the plasma air purifier 22B are very effective against mold spores, bacteria and/or viruses.

As can also be seen from FIG. 1, the air purification device 20 is activated in the idle state of the vehicle via a remote control unit 30 designed as a remote radio controller. Alternatively or additionally, the air purification device 20 can also be activated via a remote control unit 30 designed as a mobile phone. The mobile phone may have a corresponding application for this purpose. Furthermore, the air purification device 20 may be activated via a programmable wake-up unit 19.1, 32. The wake-up unit 19.1, 32 can be implemented, for example, as part of an onboard control unit 19 of the air-conditioning system 10 and/or as part of the remote control unit 30. This means that the start signal S, which activates the evaluation and control unit 12 in the idle state of the vehicle 1, is generated by the wake-up unit 19.1, 32 and/or by the remote control unit 30.

As can also be seen from FIG. 1, the remote control unit 30 is connected to a communication unit 9 of the vehicle 1 via a wireless communication link 34. The communication link 34 can be implemented, for example, as a mobile radio connection and/or as an Internet connection. Via the communication link 34, the remote control unit 30 can transmit operating signals and/or the start signal S via the communication unit 9 to the evaluation and control unit 12. In addition, the evaluation and control unit 12 sends via the communication unit 9 at least one unspecified status signal to the remote control unit 30. Thus, the remote control unit 30 can receive, for example, information about the current air quality in the vehicle passenger compartment 3 or an assessment of the current air quality in the vehicle passenger compartment 3 or the current temperature in vehicle passenger compartment 3 or a current operating state of the air purification device 20 or of the air-conditioning system 10 according to the invention and output the same to the user. The operating state of the air purification device 20 may indicate which purification unit 22 is currently activated. Furthermore, the user can control with the remote control unit 30 other unillustrated remote functions, such as the indoor temperature or a seat adjustment.

As is further apparent from FIG. 1, the sensor unit 14 detects the at least one air-quality-relevant variable LG1 in the vehicle passenger compartment 3. For this purpose, the sensor unit 14 includes a first air quality sensor (not shown), which measures as the air quality-relevant variable LG1 a particle concentration in the passenger compartment of the vehicle 3. In addition, the at least one sensor unit 14 has a second air quality sensor, which is not shown in detail, which detects as air-quality-relevant variables LG1 organic compounds, such as ammonia or reducing gases, such as hydrogen sulphide, or a combination of the listed compounds. In an alternative exemplary embodiment, the sensor unit 1 may include additional sensors and components which detect additional air-quality-relevant variables LG1 in the vehicle passenger compartment 3. Alternatively, only the particle concentration or organic compounds or reducing gases may be detected. Limit values for the individual air-quality-relevant variables LG 1 in the vehicle passenger compartment 3 are stored in an unillustrated memory unit.

As can also be seen from FIG. 1, the sensor unit 14 detects at least one air-quality-relevant variable LG2 of a vehicle environment 5 and outputs the same to the evaluation and control unit 12. As is further apparent from FIG. 1, the sensor unit 14 additionally detects a temperature T in the vehicle passenger compartment 3 and outputs the same to the evaluation and control unit 12, which evaluates the passenger compartment temperature T and compares it with at least one predetermined temperature threshold value.

In the illustrated exemplary embodiment, the evaluation and control unit 12 evaluates the at least one air-quality-relevant variable LG2 of the vehicle environment 5 and/or the at least one air-quality-relevant variable LG 1 of the vehicle passenger compartment 3 and/or the passenger compartment temperature T and switches, depending on the evaluation, from the fresh air mode or mixed air mode of the air purification device 20 into the recirculation mode, or switches from the recirculation mode of the air purification device 20 into the fresh air mode or in the mixed air mode. In the illustrated exemplary embodiment, the evaluation and control unit 12 switches the air purification device 20 into the recirculation mode when the quality of the ambient air is worse than the quality of the air in the vehicle passenger compartment 3. In addition, the evaluation and control unit 2 switches the air purification device 20 into the fresh air mode or mixed air mode when the quality of the ambient air is better than the quality of the air in the vehicle passenger compartment 3 to accelerate the purification process.

The evaluation and control unit 12 activates a heating device 16, which increases the temperature T in the vehicle passenger compartment 3 when the passenger compartment temperature T is below a predetermined first temperature threshold value. Alternatively, the evaluation and control unit 12 activates a cooling device 18, which lowers the temperature T in the vehicle passenger compartment 3 when the passenger compartment temperature T is above a predetermined second temperature threshold value.

As further evident from FIG. 1, a user may input via the portable remote control unit 30 and/or the onboard control unit 19 a time interval until the time of departure or the time of departure or both. The onboard control unit 19 or the remote control unit 30 transmit the inputted data to the evaluation and control unit 12. The evaluation and control unit 14 determines from the current time and the time of departure the time interval to the time of departure. Alternatively or additionally, the evaluation and control unit 14 determines the time of departure from the current time and the entered time interval. Alternatively, an additional evaluation and control unit, not shown, of the remote control unit 30 can determine the time interval until the time of departure from the current time and the time of departure, or can determine the time of departure from the current time and the entered time interval, wherein the data are transmitted to the evaluation and control unit 14 as control signals via the wireless communication link 34 and the communication unit 9. In addition, the user can enter a desired target air quality, which the evaluation and control unit 14 stores as an air quality threshold value, with which the currently determined air quality of the vehicle passenger compartment 3 is compared.

In the illustrated exemplary embodiment, the evaluation and control unit 12 determines an activation time and/or a deactivation time and/or a purification interval and/or a purification performance of the air purification device 20 depending on the air quality to be achieved in the vehicle passenger compartment 3 at the time of departure and in dependence on the current air quality in the vehicle passenger compartment 3 and/or the current air quality in the vehicle environment 5. This means that the air in the vehicle passenger compartment 3 is purified and fresh at the time of departure. Harmful ozone generated during the purification of the air in the vehicle passenger compartment 3 with the ozone purifier 22C and/or the plasma air purifier 22B is reduced at the time of departure. In this case, the specified air quality may correspond to the air quality set by the user or the stored air quality. The activation time and/or the deactivation time of the respective purification unit 22 is dependent on the current air-quality-relevant variables LG 1 in the passenger compartment 3 as well as on the entered time interval until the time of departure or on the time of departure and the stored target air quality in the passenger compartment 3. Furthermore, the ozone-generating or ozone-emitting purification units 22 are deactivated before the time of departure, wherein the time interval between the deactivation time and the time of departure is selected so that the ozone is reduced until the start of the trip. The purification performance of the filter device 22A is adjusted by the fan which determines the amount of air flowing through the filter device 22A. The air the passenger compartment 3 can be purified before the start of the trip depending on the air quality of the vehicle environment 5 in the recirculation mode or in the fresh air mode or in the mixed mode.

In the illustrated exemplary embodiment, the purification of the air in the vehicle passenger compartment 3 and air-conditioning of the vehicle passenger compartment 3 starts by outputting the start signal S to the evaluation and control unit 12. Furthermore, the purification performance of the individual purification units 22 and the duration or the deactivation time is set automatically by the evaluation and control unit 12. The evaluation and control unit 12 deactivates the air purification device 20 when a predetermined time interval has expired and/or a predetermined deactivation time has been reached and/or a predetermined air quality in the vehicle passenger compartment 3 has been achieved.

As also shown in FIG. 1, the evaluation and control unit 12 receives status information of a vehicle locking system 7 and at least partially deactivates the air purification unit 20 when the status information of the vehicle locking system 7 indicates that at least one vehicle door has changed from the locked state to the unlocked state. By unlocking one of the vehicle doors, the evaluation and control unit 12 detects an early time of departure and, in particular, deactivates the ozone purifier 22C and the plasma air purifier 22B. In addition, an unillustrated output unit can output an optical and/or audible warning message, indicating the wait time, after which the vehicle can be entered, or the time at which the vehicle can be entered.

The pure recirculation mode is implemented by extracting with the fan an air flow from the vehicle passenger compartment 3, supplying the extracted air flow to the air purification device 20 and the heater 16 or the cooling device 18, and thereafter feeding the purified and temperature-controlled air flow back to the vehicle passenger compartment 3. The pure fresh air mode is implemented by extracting an air flow from the vehicle environment 5, supplying the same to the air purification device 20 and to the heater 16 or the cooling device 18, and thereafter feeding the purified and temperature-controlled air flow to the vehicle passenger compartment 3. At the same time, air is discharged from the vehicle passenger compartment 3 into the vehicle environment 5. Aside from pure fresh air mode and the pure recirculation mode a mixed mode with numerous variants can be implemented, which have different proportions of fresh air and air from the vehicle passenger compartment 3.

### LIST OF REFERENCE SYMBOLS

1 vehicle
3 vehicle passenger compartment
5 vehicle environment
7 vehicle locking system
9 communication unit
10 air-conditioning system
12 evaluation and control unit
14 sensor unit
16 heating device
18 cooling device
19 control unit
19.1 wake-up unit
20 air purification device
22 purification unit
22A filter device
22B plasma air purifier
22C ozone purifier
24 filter element
26 electrostatic filter
30 remote control unit
32 wake-up unit
34 communication link
S start signal
LG1 air quality in the vehicle passenger compartment
LG2 air quality in the vehicle environment
T temperature in the vehicle passenger compartment

What is claimed is:

1.-18. (canceled)

19. An air-conditioning system for a vehicle, comprising:
at least one sensor unit, which measures at least one air-quality-relevant variable in a vehicle passenger compartment,
an evaluation and control unit, which evaluates the at least one measured air quality relevant variable, and
an air purification device, which purifies the air of the vehicle passenger compartment in one of a recirculation mode, a fresh air mode and a mixed air mode,
wherein the evaluation and control unit is activated by a start signal in an idle state of the vehicle and determines via the at least one sensor unit a current air quality in the passenger compartment, with the evaluation and control unit then activating the air purification device when the current air quality in the vehicle passenger compartment determined from the at least one measured air-quality-relevant variable meets at least one predetermined first criterion, and
wherein the air purification device purifies the air of the passenger compartment before a time of departure of the vehicle.

20. The air-conditioning system of claim 19, wherein the air purification device comprises at least one purification unit.

21. The air-conditioning system of claim 20, wherein a first purification unit is implemented as a filter device having at least one filter element.

22. The air-conditioning system of claim 20, wherein a second purification unit is implemented as a plasma air purifier having at least one electrostatic filter.

23. The air-conditioning system of claim 20, wherein a third purification unit is implemented as an ozone purifier.

24. The air-conditioning system of claim 19, further comprising a programmable wake-up unit or a remote control unit, or both, generating the start signal (S) and transmitting the start signal to the evaluation and control unit.

25. The air-conditioning system of claim 24, wherein the remote control unit transmits the start signal to the vehicle via a wireless communication link when the vehicle is in an idle state.

26. The air-conditioning system of claim 24, wherein the wake-up unit is programmable via the remote control unit and/or via an onboard control unit in the vehicle.

27. The air-conditioning system of claim 26, wherein a time interval until the time of departure or the time of departure are programmable.

28. The air-conditioning system of claim 19, wherein the at least one sensor unit measures at least one second air-quality-relevant variable of a vehicle environment and outputs the at least one second air-quality-relevant variable to the evaluation and control unit, which evaluates the at least one second air quality-relevant variable.

29. The air-conditioning system of claim 19, wherein the at least one sensor unit measures a temperature in the vehicle passenger compartment and outputs the measured temperature to the evaluation and control unit, which evaluates the measured temperature and compares the measured temperature with at least one predetermined temperature threshold value.

30. The air-conditioning system of claim 28, wherein the evaluation and control unit, in dependence on at least one of second the air-quality-relevant variable of the vehicle environment, the air-quality-relevant variable of the vehicle passenger compartment, and a temperature measured in the vehicle passenger compartment, switches the air purification device from the fresh air mode or the mixed air mode into the recirculation mode, or switches the air purification device from the recirculation mode into the fresh air mode or the mixed air mode.

31. The air-conditioning system of claim 19, wherein the evaluation and control unit determines at least one of an activation time, a deactivation time, a purification interval and a purification performance of the air purification device in dependence on at least one of an air quality to be achieved in the passenger compartment, the current air quality in the vehicle passenger compartment and a current air quality in the vehicle environment.

32. The air-conditioning system of claim 19, wherein the evaluation and control unit deactivates the air purification device when the current air quality in the passenger compartment meets at least one predetermined second criterion.

33. The air-conditioning system of claim 29, wherein the evaluation and control unit activates a heating device, which increases the temperature in the vehicle passenger compartment, when the passenger compartment temperature is below a predetermined first temperature threshold value, or activates a cooling device, which lowers the temperature in the vehicle passenger compartment, when the passenger compartment temperature is above a predetermined second temperature threshold value.

34. The air-conditioning system of claim 19, wherein the evaluation and control unit receives status information of a vehicle locking system and at least partially deactivates the air purification device when the status information of the vehicle locking system indicates that at least one vehicle door has changed from a locked state to an unlocked state.

35. The air-conditioning system of claim 34, wherein the evaluation and control unit emits via a visual warning device or via an audible warning device a warning message when the air purification device is activated at a time of the change to the unlocked state.

36. The air-conditioning system of claim 35, wherein the evaluation and control unit outputs the warning message for a predetermined period of time or displays via the warning message a time at which the vehicle can be entered.
